(19) United States
(12) Patent Application Publication
(10) Pub. No.: US 2006/0187403 A1
(43) Pub. Date: Aug. 24, 2006

(54) Micro polymerization catalyzed by external acid source for chemical lithography

(76) Inventors: Peng Yao, Newark, DE (US); Dennis W. Prather, Newark, DE (US); Janusz Murakowski, Newark, DE (US); Garrett Schneider, New Castle, DE (US)

Correspondence Address: CONNOLLY BOVE LODGE & HUTZ LLP, SUITE 800, 1990 M STREET NW, WASHINGTON, DC, 20036-3425, US

(21) Appl. No.: 11/330,088

(22) Filed: Jan. 12, 2006

Related U.S. Application Data
(60) Provisional application No. 60/642,988, filed on Jan. 12, 2005.

(51) Int. Cl. G02F 1/13

(52) U.S. Cl. 349/187

(57) ABSTRACT

A method for generating images in polymers comprising: preparing a template with an extruding desired pattern; contacting a surface of a polymer with a desired pattern of the extruded surface of the template; treating the surface of the polymer with at least one of a liquid acid and vapor; treating the surface of the polymer with a high temperature for crosslinking; separating the template and polymer and revealing an acid imprint of the desired pattern on the surface of the polymer; baking the polymer to drive diffusion of the acid; and developing the polymer with at least one of a wet and dry process to produce a negative pattern in the polymer.

### BACKGROUND OF THE INVENTION

The present invention relates to a method for micro polymerization that is catalyzed by an external acid source. In particular, the present invention is directed to various methods for chemical lithography.

The several decades old expansion in electronics industry that spawned the economic boom of the later part of the twentieth century has been possible by what has become known as Moore's law. It states that the number of functional elements integrated on a single chip doubles every 18 months. At the core of Moore's law lie advances in lithography that enable ever-shrinking minimum size of features that can be patterned on a semiconductor substrate. The workhorse of lithography in the microelectronic industry has been photolithography where the image of the functional elements and circuits is projected onto the semiconductor surface coated with photosensitive material—the resist.

As the minimum feature patterned on modern integrated circuits falls below 200 nm, classical projection photolithography is put under enormous pressure to satisfy the demands of the industry. Sustaining progress along this path requires switching to ever-shorter wavelengths to overcome the fundamental barrier of optical resolution. While efforts in this direction are under way, the skyrocketing cost of this approach has prompted many to look for alternatives. In addition, a host of new applications has emerged where the traditional photolithography may not be optimal if at all viable. Chief among them are applications related to controlling light propagation on a wavelength scale, or integrated micro-photonics and nano-photonics. Similar to the microelectronics industry, they require patterning of features at a deep submicron and approaching nano-scale.

However, in contrast to electronic circuits where planar binary lithography is adequate, photonic applications often require tight control of structure geometry in all three dimensions. For example, making an efficient micro-lens requires high-resolution patterning of a smoothly varying surface. In addition, a photonic crystal with a complete bandgap is only possible when a structure periodic in all three dimensions is attained. Such feats are outside of the scope of the highly specialized planar lithography developed in the context of micro-electronic circuitry. The bottom line is that while high-resolution lithography is a necessary condition, it is certainly not sufficient to attain the goal of fabricating micro- and nano-devices other than electronic circuits.

Accordingly, while for example nano-imprint lithography, which relies on molding a layer of resist in the shape of a template, has proven to be enormously successful in replicating nanometer-size features, it may be not entirely suitable to achieve goals of fabricating devices other than electronic circuits.

Therefore, there is a need in the art to expand the toolbox of available lithography techniques that would allow for high-resolution rapid replication of structures and overcome the limitations of currently available methods.

### BRIEF SUMMARY OF THE INVENTION

The present invention is an alternative to conventional lithography methods for generating images in polymers. Unlike background art techniques, which use photon-generated acid to catalyze cross-links, the method of the present invention directly introduces acid to the resist from an external source. As a result, the image generated in the polymer is determined by the location of the acid introduced and its diffusion profile in the surface of the polymer. Further, the method of the present invention may include curing the resist through exposure to a predetermined light source that may further enhance the formation of a final structure.

The present invention is based on a method for chemically changing the properties of the surface of a polymer layer (i.e., the resist) by bringing it in contact with a desired pattern on a master template. The present invention is expected to offer resolution of well below 100 nm, comparable to the resolution of the nano-imprint lithography. In addition, the present invention will bypass one of the main limitations of nano-imprint lithography. That is, the present invention: (1) provides for a direct shaping of the surface of the polymer with the template and thus, reduces stress in the latter, (2) contributes to longevity; (3) improves pattern fidelity and yield; and (3) relaxes requirements for the template preparation process.

Further, having a latent image in the surface of the polymer that is encoded in its chemical structure rather than its shape makes the method of the present invention: (1) more flexible than background art techniques; (2) opens the possibility of further processing the resist layer(s) before developing it; and (3) converts the chemical contrast into a shape. These features of the method of the present invention will make it possible to: (1) deposit and pattern subsequent layers of resist; or (2) produce-three-dimensional photonic crystal latent images by holographic lithography in the volume of the resist while patterning highly localized defects, such as waveguides or resonators, in the thin layer by chemical imprint

One embodiment of the present invention is a method for generating images in polymers comprising: preparing a template with an extruding desired pattern; forming a thin film of acid on the surface of the template; contacting a surface of a polymer with the desired pattern of the extruded surface of the template; separating the template and polymer to reveal an acid imprint of the desired pattern on the surface of the polymer; baking the polymer to drive diffusion of the acid; and developing the polymer with at least one of a wet and dry process to produce a positive pattern in the polymer.

Another embodiment of the present invention is a method for generating images in polymers comprising: preparing a template with an extruding desired pattern; contacting a surface of a polymer with a desired pattern of the extruded surface of the template; treating the surface of the polymer with at least one of a liquid acid and vapor; treating the surface of the polymer with a high temperature for crosslinking; separating the template and polymer and revealing an acid imprint of the desired pattern on the surface of the polymer; baking the polymer to drive diffusion of the acid; and developing the polymer with at least one of a wet and dry process to produce a negative pattern in the polymer.

### BRIEF DESCRIPTION OF DRAWINGS

FIG. 1(a) to FIG. 1(f) illustrate the method for chemical lithography fabrication of the present invention using a positive process;

FIG. 2 is a flow diagram of the method of chemical lithography fabrication using a positive process;

FIG. 3 shows experimental results from the method of the present invention for chemical lithography using a positive process;

FIG. 4(a) to FIG. 4(d) illustrates the method for chemical lithography fabrication of the present invention using a negative process;

FIG. 5 is a flow diagram of the method of chemical lithography fabrication using a negative process;

FIG. 6 shows experimental results from the method of the present invention for chemical lithography using a negative process;

FIG. 7 shows the implementation of chemical lithography using prototyping method. The acid is transferred to the polymer surface by an AFM (atomic force microscope) tip;

FIG. 8(a) to FIG. 8(d) show some experimental results of the chemical lithography process using solid acid;

FIG. 9(a) to FIG. 9(e) show the diffusion of acid at different situations;

FIG. 10 shows the one possible 3D profile that can be realized by controlling the external field upon acid diffusion process;

FIG. 11 shows the application of chemical lithography on gray scale lithography. It is realized by varying the acid strength at different positions.

FIG. 12 shows the processing steps of the silylation-based chemical contact lithography;

FIG. 13 shows a “Bilayer” process based on direct transfer of silylation reagent or un-cross-linked resist by contact;

### DETAILED DESCRIPTION OF THE INVENTION

The chemical lithography method of the present invention may be implemented as either a positive process or a negative process. The positive process uses a previously prepared template to transfer acid to the contacted areas between polymer and the extrusive patterns on the template, and therefore results in the same acid-distribution-image as the patterns on the template. The negative process uses a previously prepared template to block the acid transferring, and therefore generates a negative (reversed) acid image relative to the patterns on the template. The positive and negative processes will be further described in the following paragraphs.

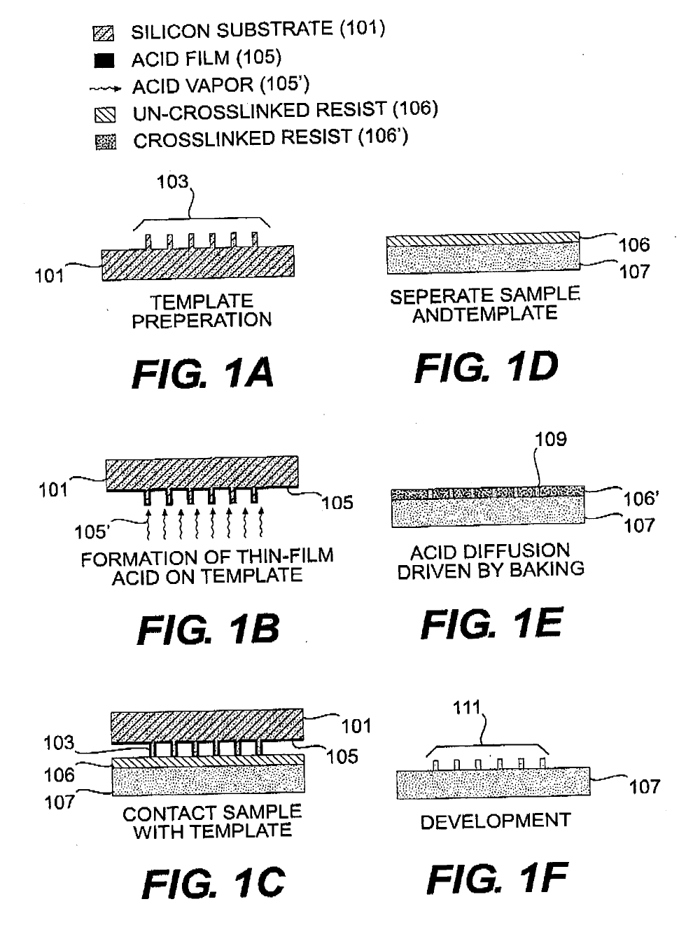

The method for chemical lithography fabrication of the present invention using a positive process is shown in FIG. 1(a) to FIG. 1(f). Initially, as shown in FIG. 1(a), a template 101 is prepared that contains a desired pattern 103 that extrudes from the template 101. FIG. 1(b) shows the template 101 is next coated with a thin film of acid 105. As discussed above, the thin film of acid may be, but is not limited to a solid acid. In FIG. 1(c), the acid 105 that is located on the portion that extrudes from the template 101 and that contains the desired pattern 103 is transferred from the template 101 to a surface of a polymer 107 coated with an un-crosslinked resist 106 in the area that is contacted by the desired pattern 103. The template 101 and the surface of the polymer 107 are separated in FIG. 1(d). As shown in FIG. 1(e), the transferred acid 109 diffuses into the surface of the polymer 107 coated with a un-crosslinked resist 106 to form a modified surface of the polymer 106′. Following a baking process, the modified surface of the polymer 106′ presents different solubility or etching rate characteristics than the original surface of the polymer 107. In FIG. 1(f), the modified surface of the polymer 106′ is further developed using either a wet or dry developing process that produces a positive pattern 111 in the modified surface of the polymer 106′.

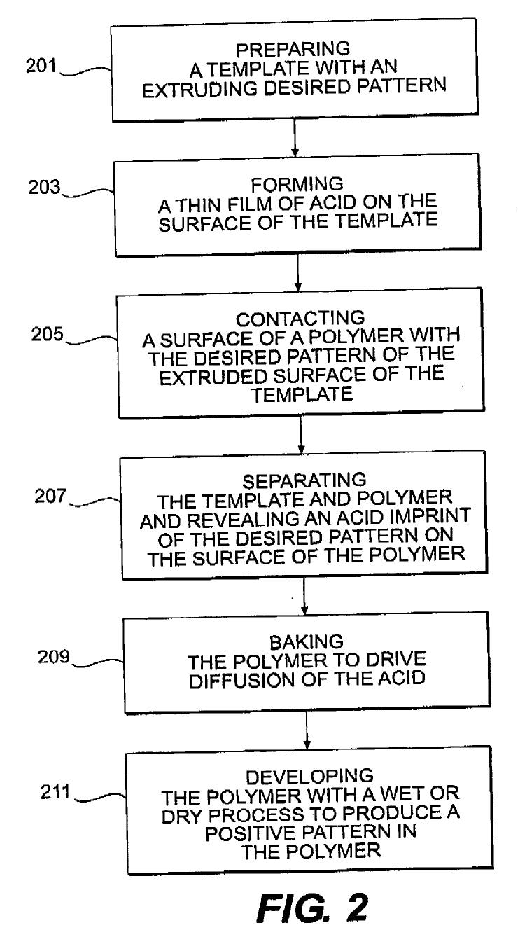

FIG. 2 is a flow diagram of the method of chemical lithography fabrication using a positive process. Step 201 of FIG. 2 is preparing a template with an extruding desired pattern. In step 203 of FIG. 2, a thin film of acid is formed on the surface of the template. Contacting a surface of a polymer with the desired pattern on the extruded surface of the template occurs in step 205. Step 207 is separating the template and polymer and revealing an acid imprint of the desired pattern on the surface of the polymer. In step 209, the polymer is baked to drive the diffusion of the acid in the polymer. Developing the polymer with a wet (with suitable developer) or dry process (using O₂ plasma etching) to produce the positive pattern in the polymer occurs in step 211.

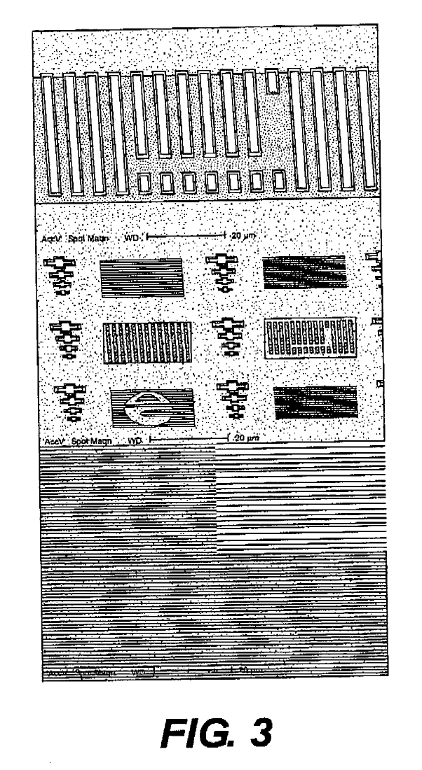

FIG. 3 shows experimental results from the method of the present invention for chemical lithography using a positive process. Top micrograph of FIG. 3 shows extrusive polymer lines that have 3 μm feature size; Middle micrograph of FIG. 3 shows larger view of different pattern areas that are formed by positive process; Bottom micrograph of FIG. 3 shows enlarged view of the sidewall profile of the polymer structures. These experimental results are realized by using Hydrochloric acid (HCL) as the external acid source.

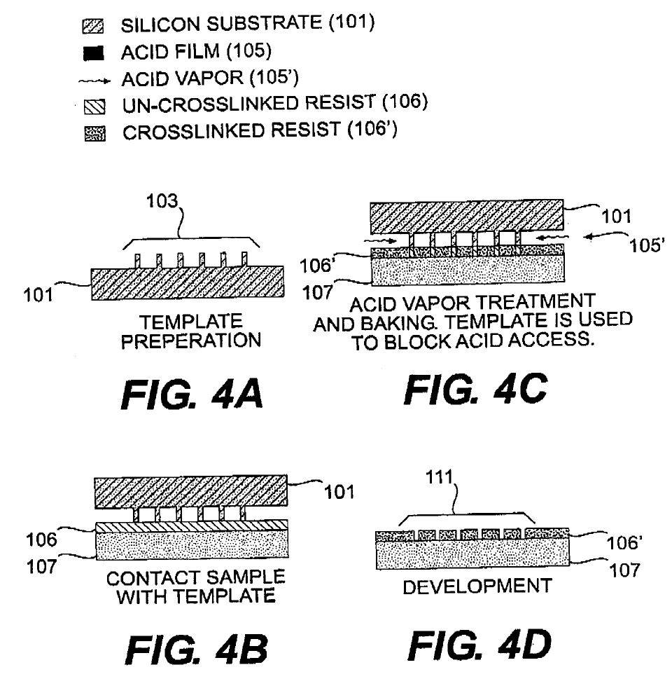

The method for chemical lithography fabrication of the present invention using a negative process is shown in FIG. 4(a) to FIG. 4(d). Initially, as shown in FIG. 4(a), a template 101 is prepared that contains a desired pattern 103 that extrudes from the template 101. FIG. 4(b) shows the template 101 is next brought into tight contact with a surface of a polymer 107 coated with a un-crosslinked resist 106. In FIG. 4(c), at least one of liquid acid 105′ or acid vapor 105″ (not shown) can be used to transfer acid to those areas of the surface of the polymer 107 coated with an un-crosslinked resist 106 that are not contacted by the desired pattern 103 that extrudes from the template 101. A baking process creates crosslinked resist 106′ at areas that are not blocked by the template 101 during the acid transferring process. After the template 101 and the surface of the polymer 107 originally coated with un-crosslinked resist 106 are separated, the result is a modified surface of the polymer 106′ that presents different solubility or etching rate characteristics than the original uncross-linked resist surface of the polymer 107. In FIG. 4(d), the modified surface of the polymer 106′ is developed using either a wet (with a suitable developer) or dry developing process (using O₂ plasma etching) that produces a negative pattern 111 in the modified surface of the polymer 106′.

It should be noted that the negative process is limited by the geometry of desired patterns 103 on the template 101. The desired patterns 103 on the template 101 need to be “open” where the template 101 contacts the surface of the polymer 107 so that there are paths for the flow of the vapor or liquid acid used in the invention.

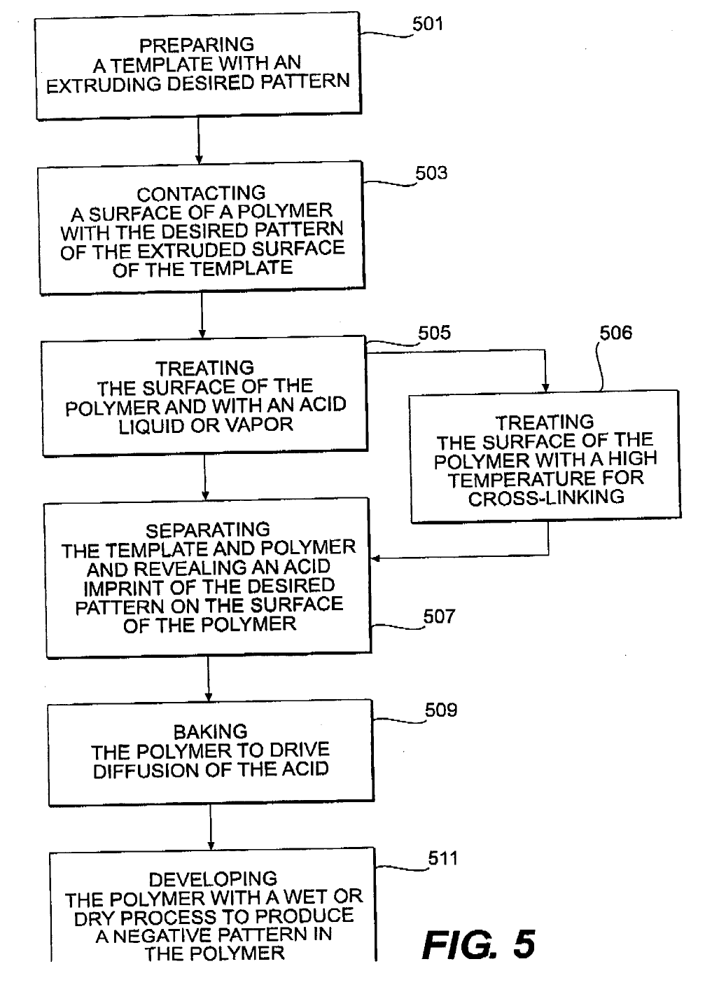

FIG. 5 is a flow diagram of the method of chemical lithography fabrication using a positive process. Step 501 of FIG. 5 is preparing a template with an extruding desired pattern. Contacting a surface of a polymer with the desired pattern on the extruded surface of the template occurs in step 503. In step 505, the surface of the polymer is treated with an acid liquid or an acid vapor. Optional step 506 is treating the surface of the polymer with a high temperature for the purpose of cross-linking. Step 507 is separating the template and polymer and revealing an acid imprint of the desired pattern on the surface of the polymer. In step 509, the polymer is baked to drive the diffusion of the acid in the polymer. Developing the polymer with a wet (with a suitable developer) or dry process (using O₂ plasma etching) to produce the negative pattern in the polymer occurs in step 511.

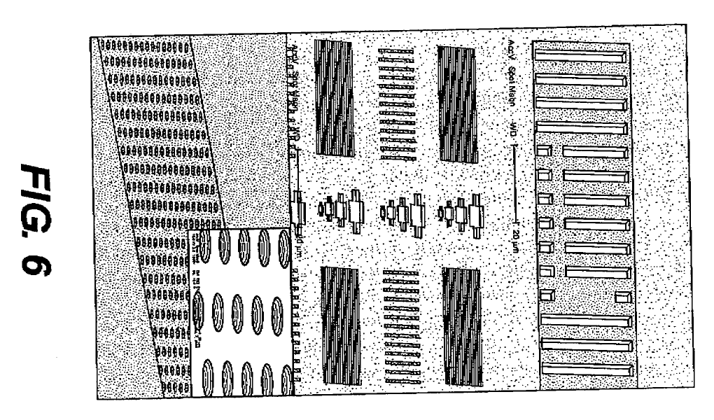

FIG. 6 shows experimental results from the method of the present invention for chemical lithography using a negative process. Top micrograph of FIG. 3 shows polymer grooves that have 3 μm feature size; Middle micrograph of FIG. 3 shows larger view of different pattern areas that are formed by the negative process; Bottom micrograph of FIG. 3 shows photonic crystal structures realized by the negative process. These experimental results are realized by using HCL as the external acid source.

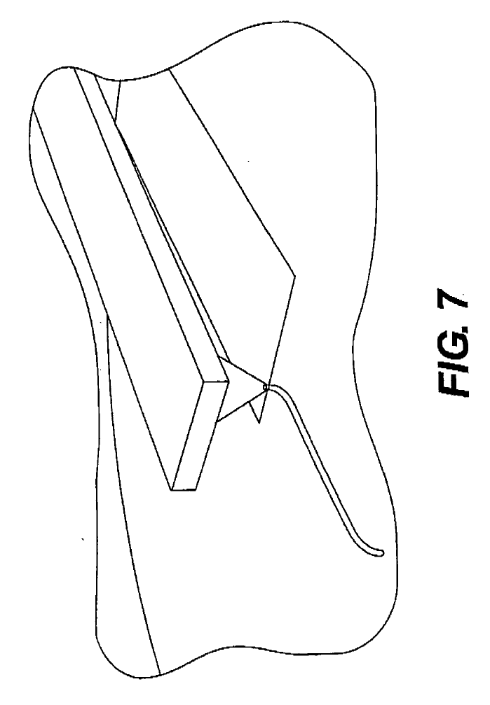

Without using a template, the chemical lithography method may also be implemented by prototyping. For example, one may use a stylus to draw acid patterns on the resist, as schematically shown in FIG. 7. In particular, FIG. 7 is an AFM (atomic force microscope) tip used for drawing nano-patterns. After applying the acid on the polymer surface, the same processing steps as shown in FIG. 1 (e) and (f) can be used to form the desired patterns in the polymer material. Since it requires no previously fabricated template, not only this method can be applied to lithography, it can also be used to fabricate templates for other chemical lithography applications. Therefore, chemical lithography is a potential self-supported lithography method.

As a proton donor, the external acid source is liquid or vapor in most cases. However, in the method of the present invention, a solid acid such as CsHSO₄ can be employed for the chemical lithography. A solid acid is a general name of a group of materials that possess “superprotonic” phase transition from salts to acids at a critical temperature. By employing solid acid in the chemical lithography process, nano-manufacturability, batch fabrication, three-dimensional capability and economy are enhanced. In addition, since solid acid is more localized after being transferred to the surface of the polymer than acid in the other phases (e.g., gas, liquid), chemical lithography using solid acid can fabricate smaller structures. Moreover, using solid acid allows better control over the process due to the facts that solid acid does not possess acidity until the temperature is raised to the “superprotonic” phase transition temperature and the conductivity of solid acid is also significantly increased after the transition. As a special acid source, solid acid can be employed in both positive and negative processes.

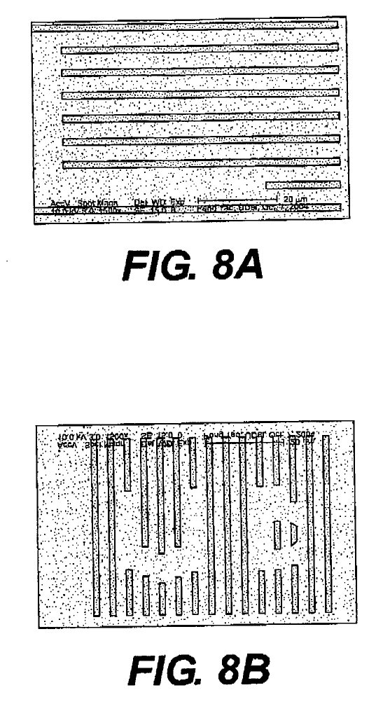

Initially, a solid acid film is deposited on the top of a previously prepared template. Methods for depositing this solid acid film include, but are not limited to vapor deposition (PVD), chemical vapor deposition (CVD) or direct chemical synthesis. The solid acid locates on the top of a desired pattern that extrudes from the template and is transferred from the template to the surface of the polymer in the contacted areas. The transferred solid acid diffuses into the surface of the polymer and modifies the polymer during a baking step that follows. The modified polymer presents different solubility or etching rate in the final wet or dry developing step than the original polymer. Finally, the modified polymer is developed to obtain the desired patterns. FIG. 8(a) to FIG. 8(d) shows some experimental results of the chemical lithography process using solid acid. FIG. 8(a) to FIG. 8(c) shows polymer structures with different geometries that are realized by chemical lithography using solid acid as external source. FIG. 8(d) shows the smallest feature size that has been realized by chemical lithography using solid acid is 178 nm.

Diffusion of acid is Important to the chemical lithography working mechanism, which applies acid to the surface only, relying on diffusion to extend features down through the resist film to the substrate. It is likely, though, that unwanted proton diffusion, particularly resolution-limiting lateral diffusion, can be controlled or even eliminated, enabling realization of the ultimate resolution limits. Further, the mobility of the catalyzing acid represents an additional process parameter that can potentially be controlled and engineered to our advantage in certain applications.

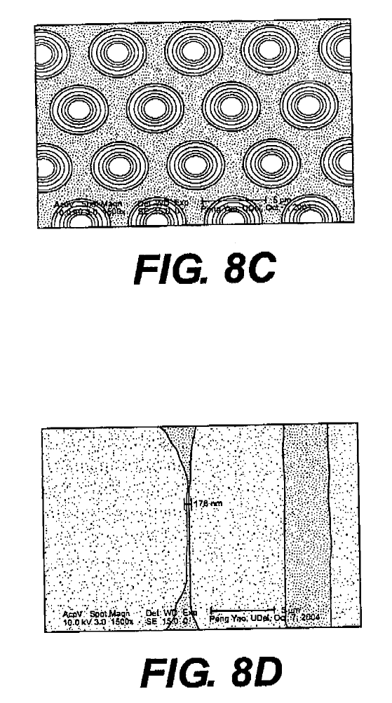

The approach to limiting the diffusion of acid of the present invention involves the application of static electric and/or magnetic fields to the sample during the diffusion, most of which occurs during the post-contact bake that drives the chemical reaction that changes the solubility of the resist (e.g. cross-linking). Since acids are by definition proton donors, and protons are charged particles, applied fields should be capable of limiting or driving the migration of protons within the resist. The anticipated effect of static applied fields on the migration paths of protons in the resist film is summarized in FIG. 9, as discussed below.

FIG. 9(a) and FIG. 9(b) illustrate the distribution of catalyzing acid and subsequent resist reaction under various diffusion conditions. FIG. 9(a) shows Isotropic diffusion. Note that for a sufficiently thick resist film (compared to the length scale of the diffusion); patterned features will not necessarily reach the substrate. FIG. 9(b) shows how isotropic diffusion will degrade the resolution attainable for a given resist thickness: in order to pattern through to the substrate acid diffuses laterally by a distance comparable to the depth. On the other hand, this diffusion profile may be desirable, e.g. for the formation of suspended structures or micro-lenses. FIG. 9(c) shows the expected distribution resulting from an applied vertical static electric field, which would bias the diffusion downward so that the reacted region reaches the substrate faster, minimizing the lateral diffusion. FIG. 9(d) shows the expected distribution resulting from the application of both an electric field and a magnetic field. The magnetic field serves to limit the lateral movement of protons. FIG. 9(e) is divided into three parts. FIG. 9(e) TOP is an Isotropic net displacement (arrows) by diffusion with no applied fields. FIG. 9(e) MIDDLE is an applied electric field (dashed arrows) will bias the migration of protons in the direction of the field. FIG. 9(e) BOTTOM shows the effect of simultaneously applying vertical electric and magnetic (dotted arrows) fields confines the protons laterally via the Lorentz magnetic force acting on the moving charged particles, while the electric field directs them downward.

In particular, a uniform vertical electric field will enforce a preferred direction for the net flow of protons, while a uniform vertical magnetic field will confine the positively charged protons to vertically oriented helical paths, owing to the transverse nature of the Lorentz force in relation to the velocity, strongly restricting or eliminating lateral diffusion and preserving template-limited pattern resolution. Applying an electric field would be particularly easy for those cases in which the template and substrate are both conductors and semiconductors: a small bias voltage applied between them is capable of creating very large electric field amplitude since they are in such close proximity during the contact printing process. A magnetic field can easily be introduced by surrounding the sample area with coils of current-carrying wire.

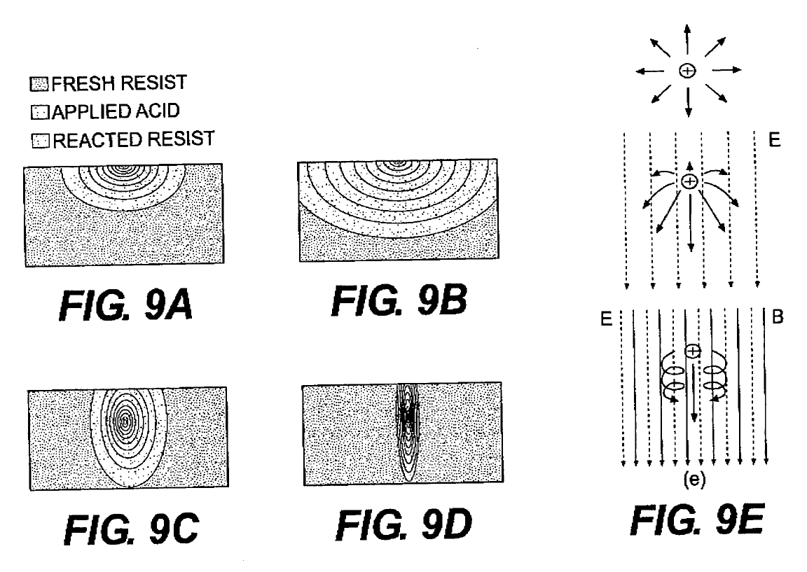

While static, vertical fields are likely to be favorable for limiting lateral diffusion and thereby preserving feature resolution and vertical sidewalls, other applications may find use in more unusual field configurations, or even time-varying fields. Such configurations may have the capability to realize complex structures embedded within a single resist layer using a single contact “exposure.” An illustration of how this possibility might be realized is shown in FIG. 10(a) and FIG. 10(b). FIG. 10 shows a simplistic picture of how the diffusion of protons from an acid source place on the surface might be directed through the resist film by time-varying applied external fields to create unique profiles.

FIG. 10(a) shows the applied fields (electric E and magnetic B) as a function of time. FIG. 10(b) is a sketch of the resist profile that might result from the sequence of applied fields shown in FIG. 10(a). If such a process were to succeed, it would be on the basis of the concurrence of the diffusion and cross-linking mentioned above. In this vision, protons migrate through the resist along a path determined by the temporal variations of the fields. As they migrate, they catalyze the resist reaction in the regions through which they travel, leaving behind a pattern, like that depicted in FIG. 10(b). Clearly this is a simplistic picture that assumes all the protons will diffuse along nearly the same path in space and time; realistically there may be wide dispersion of the proton cluster as it travels, and the surface where the acid was applied will act as an extended temporal proton source. Both these effects will complicate any directed diffusion profile engineering, and diminish both its potential feature resolution and the range of profiles attainable.

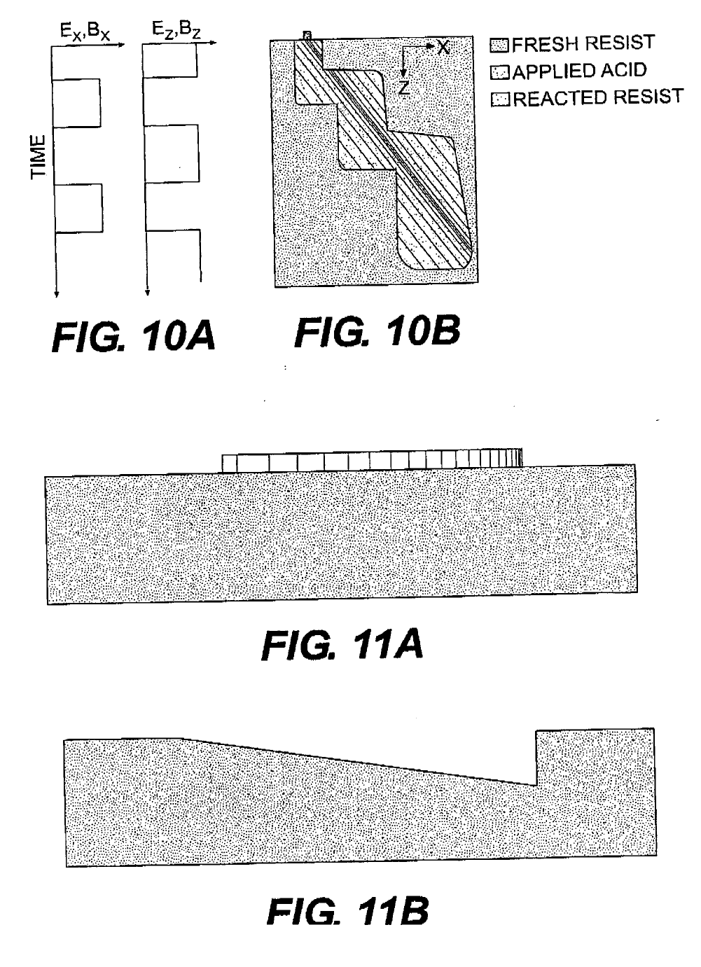

Another subject of the diffusion process of a point source is the effect of varied source strength. For example, one can expect distinct results from an infinite point source and a finite point source. We studied this effect by varying the concentration of acid solution, which is dipped on the resist surface to from the point source. The results of this study can be further applied to achieve gray scale lithography using chemical contact lithography with controlled acid concentration, as shown in FIG. 11(a) and FIG. 11(b). FIG. 11(a) and FIG. 11(b) shows a study of the diffusion of a point acid source with the variation of acid strength and that its possible application to gray scale lithography.

There are numerous possibilities for the means of realizing spatial variation of acid strength (quantity/concentration). To mention a few: (1) a dip-pen system may be modified to possess several acid reservoirs, each containing a different acid concentration. Features that are designed to have different heights in the final profile would be patterned by acid from different reservoirs, or by mixing different acid concentrations via multiple re-patterning of the same area with different acids, (2) variations in the template, e.g. height variations, could be intentionally introduced to control the efficiency of acid transfer (or in the negative process case, the efficiency of the template's ability to inhibit acid transfer).

One possible approach that may eliminate the lateral dimension expansion by shortening the diffusion path is to combine the chemical lithography with the silylation-based processes. Silylation-based dry developing processes are very well developed techniques for bilayer resist or surface imaging applications. These techniques depend on preferential incorporation of a silicon-containing compound into the photoresist after the exposure step. They usually consist of several processing steps that include exposure, silylation and O₂ plasma development. Similar to chemically amplified photolithography, the exposure step generates a latent acid image in the resist layer, which catalyzes cross-linking upon post exposure bake. The cross-linked resist has much smaller diffusion rate for the silicon-containing reagent such lick hexamethyldisilazane (HMDS, gas phase) or hexamethylcyclotrisilazane (HMCTS, liquid phase) than the un-cross-linked resist. As a result, silicon compound incorporation only takes place in un-cross-linked regions during silylation. The desired resist relief is finally “developed” by the anisotropic dry O₂ plasma etching, which is possible due to the high selectivity between silylated resist and cross-linked resist. Structures with 30 nm line width and very high aspect ration have been demonstrated using the silylation-lased method.

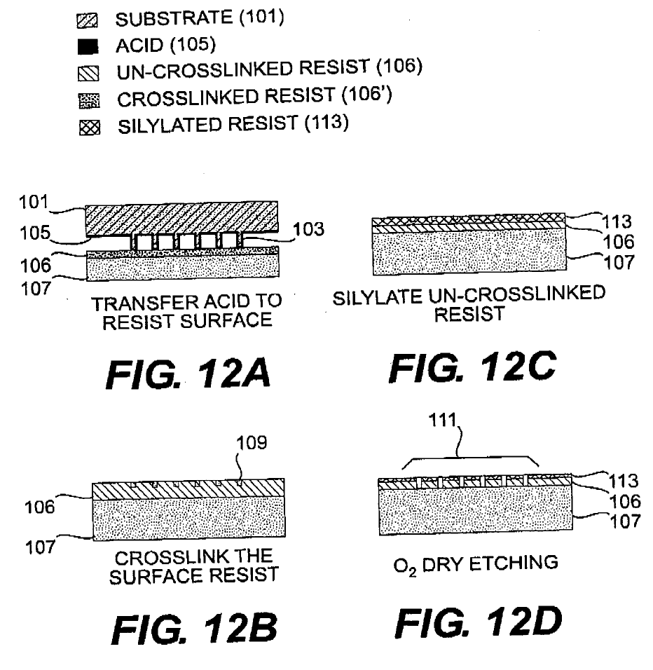

The processing steps of the silylation-based, dry-developed chemical contact lithography are depicted in FIG. 12(a) to FIG. 12(d). In particular, FIG. 12(a) to FIG. 12(d) shows a “Single layer” process: selectively incorporating a silicon compound based on different diffusion rate of reagent in cross-linked and un-cross-linked resist. FIG. 12(a) shows a template 101 coated with a thin film of acid 105. The acid 105 that is located on the portion that extrudes from the template 101 and that contains the desired pattern 103 is transferred from the template 101 to a surface of the polymer 107 coated with an un-crosslinked resist 106 in the areas of the surface that are contacted by the desired pattern 103. The template 101 and the surface of the polymer 107 coated with an un-crosslinked resist 106 are separated in FIG. 12(b) and the transferred acid 109 diffuses into the surface of the polymer 107 coated with an un-crosslinked resist 106 to form a modified surface of the polymer 106′ that is cross-linked where the transferred acid 109 is located. In FIG. 12(c) a silylation reagent 113 is applied to the uncross-linked resist 106 on the surface of the polymer 107. FIG. 12(d) shows the result of dry anisotropic oxygen plasma etches that is used to transfer the pattern 111 from top layer of resist surface to its entire thickness.

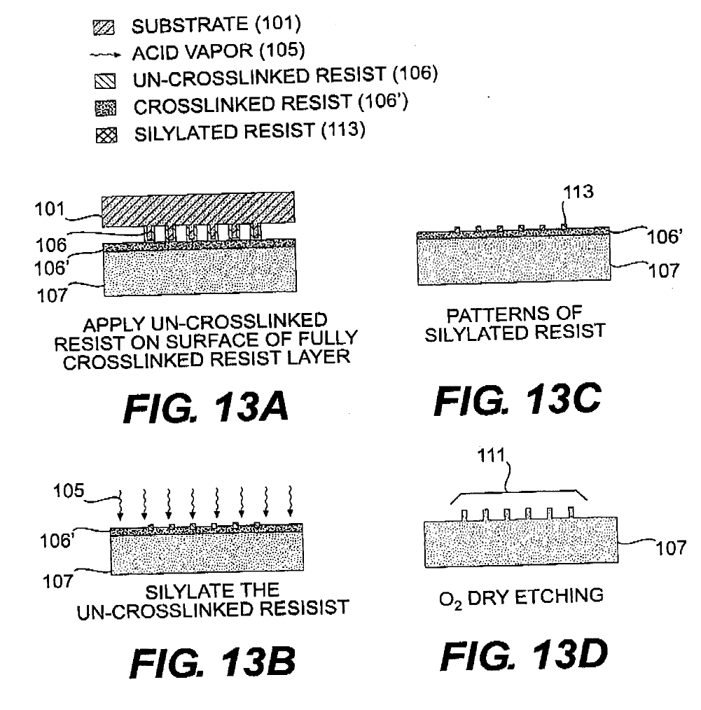

FIG. 13(a) to FIG. 13(d) show a “Bilayer” process based on direct transfer of silylation reagent or un-cross-linked resist 106 by contact. In FIG. 13(a), acid is transferred from the template to the resist surface of the polymer. The acid produces a crosslinked resist 106′ in the surface of the polymer layer. In FIG. 13(b), the un-cross-linked resist 106 is silylated. FIG. 13(c) shows the pattern 111 of the silylated resist 113 on the crosslinked resist 106′. FIG. 13(d) shows the result of dry anisotropic oxygen plasma etches that is used to transfer the pattern 111 from top layer of crosslinked resist 106′ surface to its entire thickness.

The advantages of the combination of chemical contact lithography with silylation-based dry-developing techniques include: (1) limited lateral expansion of the line width as the acid is confined to the surface in the diffusion process; (2) and sidewall profile of the final resist structure is determined by the high-aspect-ratio dry etching. Therefore, the combination is insensitive to the shape of latent acid image and the vertical roughness of the patterned lines is minimized.

The foregoing description of the present invention provides illustration and description, but is not intended to be exhaustive or to limit the invention to the precise form disclosed. Modifications and variations are possible in light of the above teachings or may be acquired from practice of the invention. The scope of the invention is defined by the claims and their equivalents.

I claim:

1. A method for generating images in polymers comprising:
preparing a template with an extruding desired pattern;
forming a thin film of acid on the surface of the template;
contacting a surface of a polymer with the desired pattern of the extruded surface of the template;
separating the template and polymer to reveal an acid imprint of the desired pattern on the surface of the polymer;
baking the polymer to drive diffusion of the acid; and
developing the polymer with at least one of a wet and dry process to produce a positive pattern in the polymer.

2. A method for generating images in polymers comprising:
preparing a template with an extruding desired pattern;
contacting a surface of a polymer with a desired pattern of the extruded surface of the template;
treating the surface of the polymer with at least one of a liquid acid and vapor;
treating the surface of the polymer with a high temperature for crosslinking;
separating the template and polymer and revealing an acid imprint of the desired pattern on the surface of the polymer;
baking the polymer to drive diffusion of the acid; and
developing the polymer with at least one of a wet and dry process to produce a negative pattern in the polymer.
